(19) United States
(12) Patent Application Publication
(10) Pub. No.: US 2008/0246656 A1
(43) Pub. Date: Oct. 9, 2008

(54) Automatic GPS tracking system with passive battery circuitry

(76) Inventor: Ohanes D. Ghazarian, Henderson, NV (US)

Correspondence Address: OHANES D. GHAZARIAN, 2575 W. HORIZON RIDGE PKWY #1611, HENDERSON, NV, 89052, US

(21) Appl. No.: 12/001,937

(22) Filed: Dec. 12, 2007

Related U.S. Application Data
(63) Continuation-in-part of application No. 11/411,164, filed on Apr. 25, 2006, now abandoned.

(51) Int. Cl. G01S 5/14; H04B 1/38

(52) U.S. Cl. 342/357.07; 455/343.2

(57) ABSTRACT

An automatic GPS tracking system is taught that consists of a GPS tracking unit secured to a person or an asset that includes a GPS receiver and a first battery operated a processor and first RF transceiver which emits an RF signal. A home base station receives the RF signal within a pre-selected proximity communication distance. A monitoring station which is in communication from a cellular modem or a satellite modem within the GPS tracking unit such that, if a person or asset having the tracking system secured thereon moves beyond the a pre-selected proximity communication distance from a home base unit, the first transceiver RF communication signals is lost, the processor automatically powers “on” the second battery to power up the GPS receiver and the cellular modem, and the GPS tracking unit may signal the monitoring station which displays the location of the person or asset.

### CROSS REFERENCE TO RELATED APPLICATION

This application is a Continuation-In-Part of patent application Ser. No. 11/411,164 filed Apr. 25, 2006.

### TECHNICAL FIELD

The present invention relates to tracking of objects to provide location information. More specifically, the present invention relates to a GPS tracking system worn or installed on persons, or assets utilizing one or preferably two separate batteries as a power supply, which definitely provides an improvement to the art.

### BACKGROUND OF THE INVENTION

The invention is for tracking of individuals or assets to provide knowledge of their location with tracking GPS tags. When the subject or asset to be monitored moves away from a dedicated area, the invention provides automatic GPS monitored using a GPS unit that does not require frequent battery charging or replacement.

When the subject or asset to be monitored leaves a home base unit dedicated area, the GPS unit RF transceiver circuitry within predetermined time, detects RF communication signal loss with a home base unit located within the dedicated area, and switch ON the GPS/Cellular battery power and cold start's the GPS/cellular tracking circuitry. In a preferred embodiment of the invention the RF transceiver Automatically switches a secondary battery power on, to cold start (power up) the GPS tracking circuitry to provide its location information. The designated area includes but is not limited to; a house, a school, a prison, camp, a vehicle, a warehouse, or an aircraft etc.

In the past many different methods have been used for electronic monitoring of individuals, such as offenders, personnel, assets etc. The most common monitoring is primarily accomplished by use of a worn or attached GPS receiver, having a processor, a global positioning satellite receiver and a wireless modem for two way communication with a monitoring station, all powered by a battery. Prior art has been used for tracking offenders, or an asset based on restraint or allow-ability to enter or exit a dedicated area. This type of system includes a GPS receiver/transmitter for receiving GPS timing signals and a processor utilizing a comparator for calculating and storing a waypoint. An algorithm created by the processor calculates a mapped programmed confinement area starting from a given waypoint, and a perimeter of the physical confinement area. The comparator provides an output comparing the present position of the GPS receiver/transmitter with the programmed confinement area. The comparator output is transmitted by the receiver/transmitter to a monitoring station PC.

Such prior art teachings are found in U.S. Pat. No. 6,232,916 of Grillo et al. and U.S. Pat. No. 6,774,797 of Freathy et al. illustrating useful methods for tracking personnel or assets, in designated areas where a person, or asset, to be monitored is restrained from entering or exiting the defined zone. In order to obtain such functionality, the GPS unit used in the prior art must produce electrical power all of the time while in use. This prior art necessitates constant battery consumption, requiring frequent battery charging or replacement, in order for the GPS receiver to receive satellite signals, the comparator to function and the wireless modem to receive and transmit a signal.

Further, a more useful method found in prior art is illustrated in U.S. Pat. No. 6,104,979 of Harrison, in which he teaches a communication method for both the asset requirement and communication channel occupancy in a reduced order. The asset is provided with an indication of its position so as to allow detection of movement of the asset. Reduced order of the data at the asset, is used for shorter data transmission times. This capability can be used to save energy, for example, reporting to the central station less frequently when the asset position is unchanged. Harrison teaches centralize tracking with reduced energy consumption, however if such teaching were to be implemented in applications where an asset or person to be monitored was in an unchanged position, within a dedicated area, the invention still requires constant battery energy in order to operate GPS tracking device circuitry, even with reporting to central station less frequently.

The following U.S. patents and patent application Publications are considered related:

U.S. Patent Application Publication 2006/0202818 of Greenberg teaches a tracking system, using a battery as power source having multi-power mode. A first mode is a low power mode, when the receiver on the trackee remains within the range of a base station. A second mode, is a standby mode and a third mode is a lost trackee mode that is activated upon user authentication.

U.S. Pat. No. 7,061,385 of Fong, et al. teaches a wireless tether apparatus such that when separated from a base station unit, greater than a predetermined distance, dynamic switching communication channels send information in the form of alarm sounds, displays, vibration sequences or combinations thereof.

U.S. Pat. No. 6,889,135 of Curatolo, et al. illustrate a method wherein if two signaling units are separated more than a pre-selected distance, signaling units are activated transmitting the location of the signaling units.

U.S. Patent Application Publication 2005/0017900 of Grimm teaches a method wherein a reed switch responsive to the magnetic field of a keeper plate, within a bank teller's drawer activates a GPS/cellular modem selectively controlling a cellular or RF transmitter to help recover stolen goods.

U.S. Patent Application Publication 2004/0012518 of Mohan illustrates a method wherein a module, in form of a bracelet, is adapted with a global position satellite receiver, a communications transmitter and a controller, operative to receive a request from a remote location causing the global positioning satellite receiver to receive and decode signals from global positioning satellites containing information relating to the geographic position of the module.

U.S. Patent Application Publication 2002/0018014 of Allen teaches a trigger-able remote controller having a trigger signal including a command; a GPS processor coupled to trigger signal, and a position signal carrying position information generated by the GPS processor in response to trigger signal. The trigger signal source comprises a page receiver with the trigger signal activating when the page receiver receives a page.

U.S. Pat. No. 6,236,358 of Durst, et al. teach an object locator, such as an animal, carrying a mobile communication unit that includes a GPS receiver coupled with a pager transceiver. The GPS receiver may be selectively activated to conserve power by responding only when the GPS receiver is beyond or within a predetermined boundary.

U.S. Pat. No. 6,014,080 of Layson Jr. illustrates a body worn tracking device for use in a wireless communication system receiving signals from a global positioning system. The tracking device directly communicates selected coordinates within remote sites. The device case contains a battery, a signaling device, and a field programmable gate array for power saving.

U.S. Pat. No. 6,075,443 of Schepps et al. teach a method using a wireless tether worn on a article, transmitting a periodic identification signal. A receiving module located at a tether location receives identification signals if the tethered article moves away from the tether location at which time an alarm is raised.

U.S. Pat. No. 6,067,018 of Skelton et al. teaches a pet notification system having a pet collar that automatically activates an alarm when the pet becomes lost. A portable hand held unit continuously monitors the location of the pet. A base station automatically transmits a signal to the owner once portable unit determines that the pet is lost.

U.S. Pat. No. 5,870,029 of Otto et al. illustrate a system for monitoring the location or presence of an object/person within a selected area. The system includes a mobile base station, a control center, a mobile signaling device carried by the monitored object/person and geolocating means for retaining the monitored object/person within a desired area. An alarm condition is raised, when the monitoring object/person is not within this desired area.

U.S. Pat. No. 5,491,486 of Welles, II et al. illustrate a method where a mobile tracking unit is capable of operating in a power starved environment on a vehicle generating data corresponding to vehicle position. A navigation device is periodically energized, at selective activation rate, while vehicle is moving generating a vehicle position. A motion sensor is also employed for generating data indicative of vehicle motion, and.

U.S. Pat. No. 5,515,419 of Sheffer teaches a tracking system for tracking a portable phone, utilizing an array of fixed wireless signal transceivers forming part of a wireless telephone system. The phone unit generates an emergency signal on detection of an emergency condition, and transmits the emergency signal to a monitoring station via the wireless telephone network. The emergency signal includes information for identifying the phone.

Never less prior art teaching found in U.S. Pat. No. 6,075,443 to Schepps et al, U.S. Pat. No. 6,067,018 to Skelton et al, U.S. Pat. No. 5,870,029 Otto et al. U.S. Pat. No. 5,491,486 to Welles, II et al. U.S. Pat. No. 5,515,419 to Sheffer, as well as the other prior art GPS tracking systems found are important and useful background to the present invention, but none of prior art teaching illustrates the use of a battery powered GPS Tracking unit wherein when GPS tracking unit is located within proximity range and communicating with a low power RF signal with a home base unit, the tracking device GPS/Cellular electronic circuitry power consumption is in none existence “0”, by utilizing a power switching circuitry which is responsive to cold start (Power ON) the GPS/cellular power circuitry only upon tracking unit communication is lost with the home base unit. Contrary to teachings found in the prior arts where a “Sleep mode” or “power saver” mode or “standby” mode methods has been utilized, which each one of such teaching methods drains constant low current consumption from the battery, and if presumably an external power On/Off switch was used in the prior arts to control unnecessary power drain from the battery, by user turning manual On/Off switch to control GPS tracking power circuitry, that presumption will not be practical in use at all, because subject to be monitored before leaving a selected proximity area may forget to turn On the GPS unit power switch, and the art becomes completely useless.

Yet in a preferred embodiment of the present invention, the teaching utilizes a first battery to power and operate a tracking device RF transceiver and processor circuitry to communicate with a home base unit, and utilizes a secondary stand alone battery used specifically to power ON the GPS/Cellular circuitry to provide reserved energy for longer GPS tracking operation. Her each are incorporated herein by reference.

It is accordingly primary objective of the present invention that utilizes a Battery operated personnel or asset mount GPS tracking device, having a first battery to power a low power consumption RF transceiver and a processor, designed to communicate at time interval with a home base station RF transceiver unit, located within the communication range of the GPS tracking device. The tracking device having a second battery, which will power ON automatically to operate the GPS/Cellular circuitry only when subject to be monitored moves away from a pre-select location. The present art teaching provide less frequent GPS tracking unit battery charge for user, and ascertains user to provide longer period reserved battery power for GPS tracking.

It is accordingly a secondary objective of present invention that use a battery powered GPS Tracking unit, wherein when the GPS tracking unit is located within proximity range of a home base unit, the tracking device GPS/Cellular electronic circuitry power consumption is none in existence “0”, utilizing an RF transceiver/processor and a power switching circuitry which is responsive to cold start “power ON” the GPS/cellular power circuitry only when the tracking devise moves away from a pre-set proximity area and creating communication loss with the home base unit. The present art teaching is designed to provide less frequent battery charging for a user.

It is another objective of present invention, to provide a monitoring station(s) automatic personnel/asset movement tracking, by switching ON GPS/Cellular circuitry battery power, only when a person or asset carrying the tracking device travels away from home base unit.

It is a another objective of present invention, wherein the tracking device using a first battery to operate the processor to monitor the absence and or low battery condition of the secondary battery located within said GPS tracking device, and accordingly generates an audio/visual, vibrating alarm signal(s) to warn the user to the battery condition, and or transmits an RF alarm signal(s) containing information to the second battery condition(s) to a monitoring company.

It is further objective of present invention, wherein the present tracking device additionally contains a speaker and a microphone circuitry, utilizing the first battery for RF transceiver circuitry, and a second battery for cellular modem/phone circuitry, to establish a two way verbal communication with a monitoring station through a home base RF unit using a land line or cellular signals to establish secure two way verbal communication.

It is another objective of the present invention, wherein the tracking device additionally contains a vibrator, utilizing the first battery as power source. The vibrator is responsive to signals received from a monitoring station through the home base unit RF transceiver, to providing a call Tag to the person being monitored. And the tracking device vibrator utilizing a second battery as power source, which is responsive to signals received from a monitoring station through a cellular or satellite network, to ascertain a secured call Tag to the person being monitored.

It is further objective of present invention, wherein the tracking device additionally contains an RF secondary audio transceiver, used for providing wireless verbal communication in between a person to be monitored carrying a wireless headset, and the monitoring station

And it is further another objective of the present invention, wherein the GPS tracking device is installed on a personnel or asset, utilizing an optical sensor to detect GPS tracking device tamper (removal), and use the first battery power to transmit an RF signal containing the tamper detection signal, and use the second battery power to transmit a Cellular or Satellite signal to ascertain the temper alarm signals is been transmitted to a monitoring station successfully.

### SUMMARY OF THE INVENTION

The primary object of the invention is to provide a GPS tracking system worn or installed on persons for tracking or assets with a global positioning receiver utilizing two separate batteries for the power supply. The invention consists of a GPS tracking unit, having a processor, a GPS receiver and a satellite or cellular modem and a low power consumption RF transceiver. The GPS tracking unit utilizes a first battery for its power supply, communicating with an RF signal at time intervals with a home base station RF transceiver unit, located in a pre-selected area within the communication range of the GPS tracking unit.

The GPS tracking unit has a dedicated second rechargeable battery providing power to the GPS receiver and wireless modem circuitry. When the GPS unit is present within communication range of home base unit, the GPS unit's receiver, satellite or cellular modem battery power circuitry is in “Off” position.

If and when the asset, carrying GPS tracking unit, moves out of communication range from the home base unit, the GPS tracking unit's RF transceiver circuitry, at predetermined time, detects RF communication signal loss, and the processor switching circuitry “Power's On” the second battery to operate the GPS tracking unit receiver and satellite or cellular modem circuitry. The invention provides automatic tracking when a person or asset moves away from a pre-selected area, and conserves GPS tracking unit batteries, as only the second battery is supplying power when the GPS receiver is in use, thus providing longer period of portable GPS tracking unit operation than other prior art systems using a single battery for all functions.

Although a single battery use is applied in the present art teaches, however due to present art teaching method wherein the GPS/cellular circuitry having no battery power consumption at all when GPS tracking unit is located within proximity of a home base unit. The present art definitely provide to the art a longer battery life for GPS tracking then other prior art systems using single battery.

These and other objects and advantages of the present invention will become apparent from the subsequent detailed description of the preferred embodiment and the appended claims.

### BRIEF DESCRIPTION OF THE DRAWINGS

This and other advantages of the present invention are best understood with reference to the drawings, in which;

FIG. 1 is a view of a wearable GPS tracking unit having a tamper detection strap, a low power consumption RF transceiver, GPS receiver circuitry, GSM or satellite modem, and a single or dual battery compartment, one for providing power to RF transceiver, and the other providing power to GPS and wireless modem data communicator circuitry.

FIG. 2 is a view of an asset mounted GPS tracking unit having a low power consumption RF transceiver, GPS receiver circuitry, GSM or satellite modem, and a single or dual battery compartment, one providing power to RF transceiver, and the other providing power to GPS and wireless modem data communication circuitry.

FIG. 3 is a view of asset mount a GPS tracking unit having optical tamper detection circuitry.

FIG. 4 illustrates a person and an asset carrying GPS tracking unit, a house equipped with a home base RF transceiver unit, and a monitoring station.

FIG. 5 is a block diagram of the security tracking system.

FIG. 6 is a partial isometric view of the GPS tracking unit used for attaching to a person with a strap, in the alternate embodiment.

FIG. 7 is a partial isometric view of the GPS tracking unit for use for attaching to an asset, in the alternate embodiment.

FIG. 8 is a partial isometric view of the GPS tracking unit ready for attachment to an asset using optical tamper detection circuitry, in the alternate embodiment.

FIG. 9 is a schematic of the basic components of the GPS tracking system, in the alternate embodiment.

FIG. 10 is a block diagram of the GPS tracking system, in the alternate embodiment.

### DETAILED DESCRIPTION OF THE INVENTION

The best mode for carrying out the invention is presented in the terms of a embodiment, preferred embodiment and an alternate embodiment.

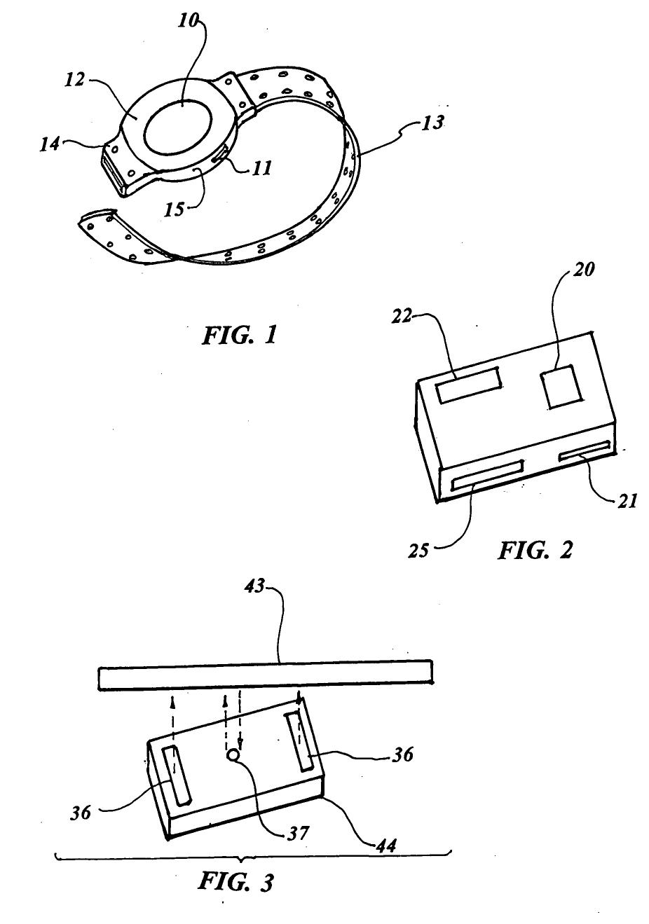

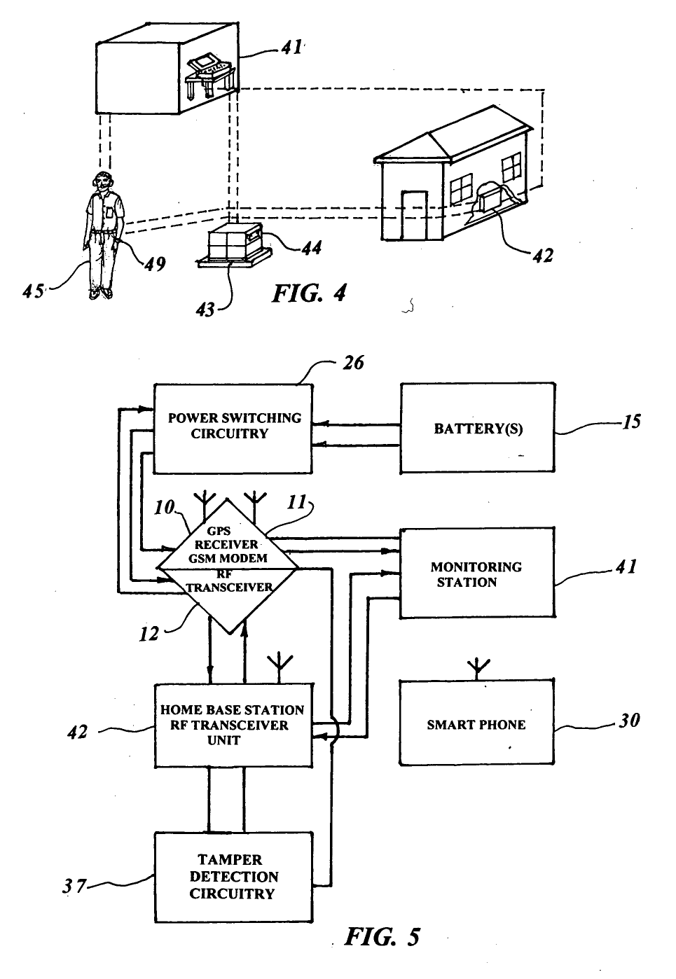

The embodiment of a GPS tracking system is shown in FIGS. 1 thorough 5 and is comprised of FIG. 4 a portable battery operated GPS tracking unit 44 to be mounted on an asset 43 or attached to a person 45, wrist or ankle 49. The GPS tracking unit 44, FIGS. 1 and 2 includes a GPS receiver 10, 20, and a cellular or satellite modem 11, 21. Incorporated in the GPS tracking unit, is a low power consumption RF transceiver 12, 22 using a battery 15, 25 or dual batteries, the first battery 15 preferably Li-Ion rechargeable battery provides power to the low power RF transceiver 12, 22, And provides power to a GPS receiver 10, 20 and a wireless communication modem 11, 21 which is also included in the tracking unit 44,49. The low power consumption RF transceiver 12,22 communicates at time intervals with a FIG. 4 home base station RF transceiver unit 42, located within the communication range of the GPS tracking unit 44, 49. When GPS tracking unit 44, 49 moves away from the home base unit 42 communication range, the tracking unit 44,49 RF transceiver circuitry 12,22 will cold start “Power ON” the GPS cellular or satellite modem 11, 21 to provide automatic GPS tracking and provide less frequent battery 15 charge to user. In another embodiment a first battery 15 preferable Lithium is used to provide power to RF transceiver 12,22 and a second battery 25 preferably a Li-Ion rechargeable, is provided to Cold start “power ON” the GPS receiver 10,20 and cellular or satellite modem 11,21. for extended life tracking unit 44,49 use. FIG. 3 illustrates the GPS tracking unit 44 being attached to an asset 43 utilizing an optical reflection motion/tamper sensor 37 included in the tracking unit 44 that alerts the FIG. 4 monitoring station 41 when removed from the asset 43. The tracking unit 44 is preferably attached to the asset 43 with hook and loop strap 36.

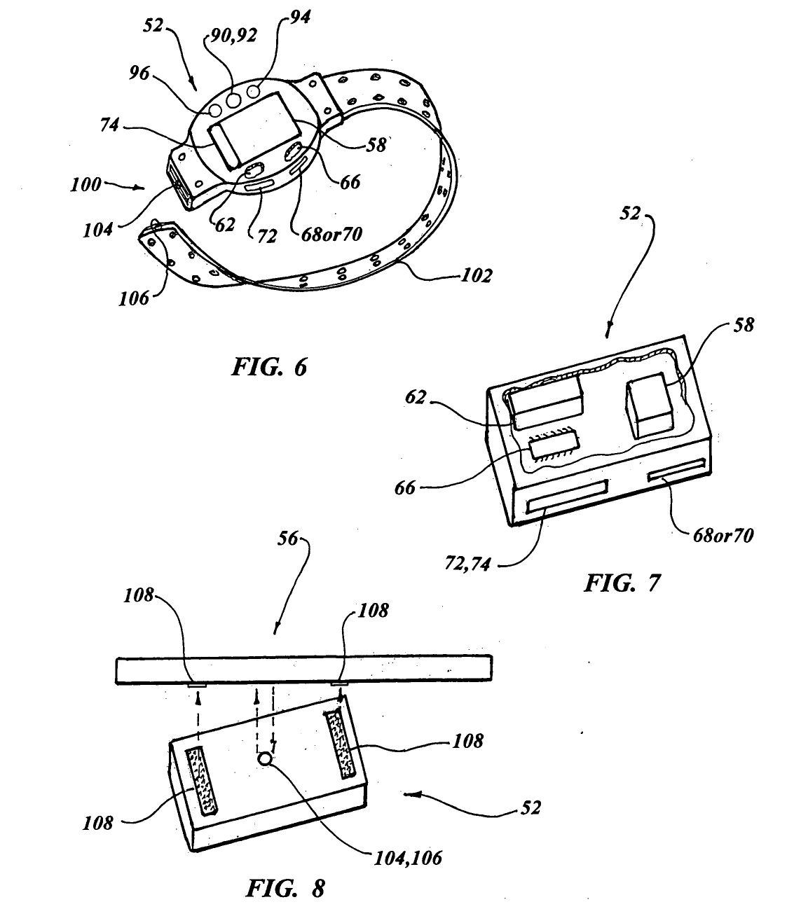

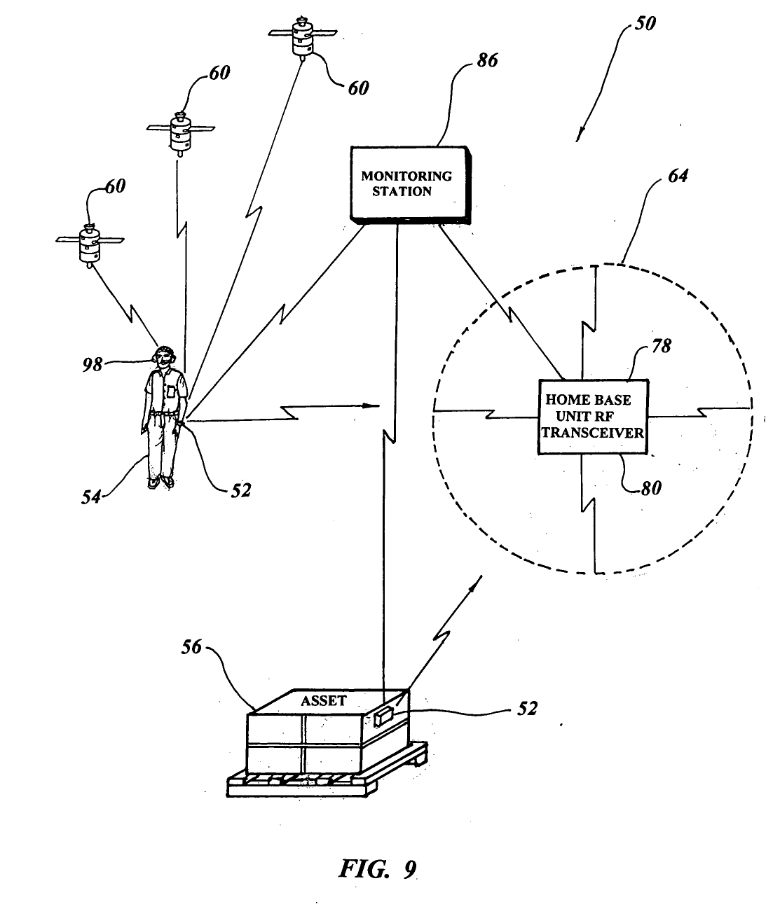

The preferred embodiment of an automatic GPS tracking system, with passive battery circuitry, is illustrated in FIGS. 6 through 10 and consists of FIG. 6 a GPS tracking unit 52 that is configured to be secured onto a person 54 or an asset 56, as shown in FIG. 9. The GPS tracking unit 52 incorporates the following elements:

FIGS. 6 and 7 A first RF transceiver 62 emitting an RF signal, and receiving a confirmation signal FIG. 9 from a home base station unit 78, demonstrating that the tracking unit 52 is within a pre-selected proximity communication distance 64.

FIGS. 6 and 7 A processor 66 is utilized that is programmed to control functions of the GPS tracking unit 52 and also controls pre-selected time intervals of the RF signal emitted from the first RF transceiver 62.

A first battery 72, preferably a Lithium type, supplies constant electrical power to both the first RF transceiver 62 and the processor 66.

A GPS receiver 58 in communication FIG. 9 with a plurality of satellites 60 acquires the specific physical location of the tracking unit 52.

FIGS. 6 and 7. A cellular modem 68 or a satellite modem 70 is utilized for communicating with FIG. 9 monitoring station 86.

FIGS. 6 and 7. A second battery 74, preferably a rechargeable Li Ion battery type, supplies electrical power to the GPS receiver 58, cellular modem 68, or a satellite modem 70. The power switching circuitry 76 interfaces with the second battery 74 powering on the second battery 74 only when the GPS tracking unit moves away from a pre-selected proximity 64 distance from the home base unit 78, and the RF confirmation signal is not received from the home base unit 78 within the pre-selected time period. When GPS tracking unit 52 enters back into RF communication proximity distance 64, the GPS tracking unit re-establishes communication with the home base unit 78, and the power switching circuitry 76 switches OFF the second GPS receiver and cellular, satellite modem battery 74 for conserving the second battery 74 life.

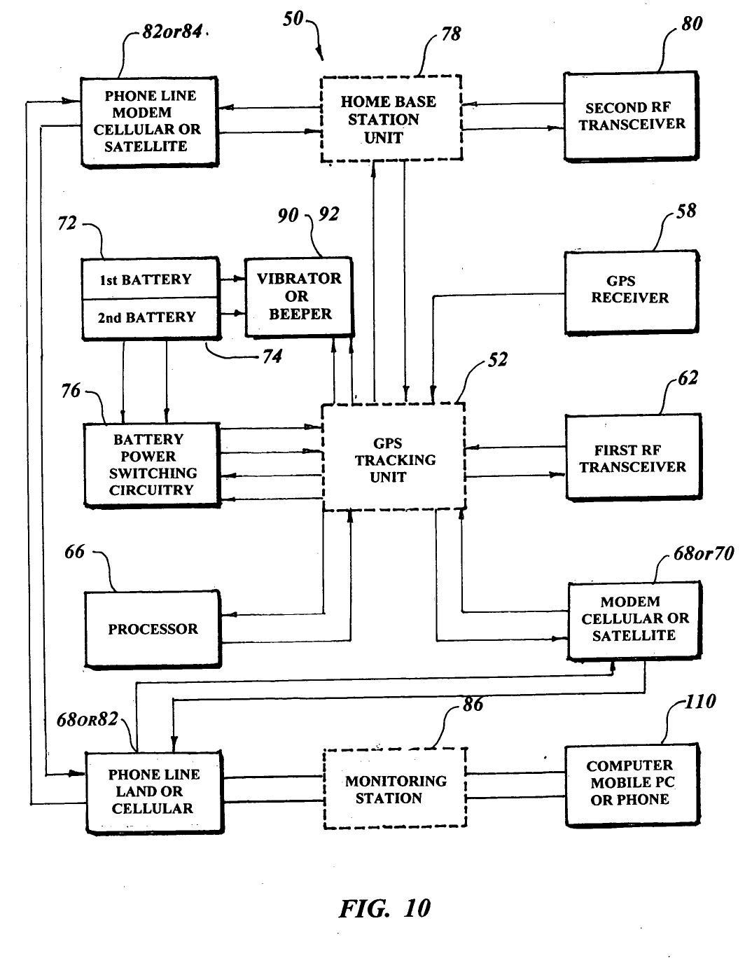

The GPS tracking unit 52 is illustrated attached to the wrist of a person 54 in FIG. 9 and shown by itself in FIG. 6 and in relationship with other elements in the block diagram of FIG. 10 FIG. 9 The GPS tracking system 50 incorporates a home base station 78, illustrated in FIGS. 7 and 8, which includes the following:

A home base unit second RF transceiver 80 which receives the RF signal from the tracking unit first RF transceiver 62 and emitts a confirmation signal back to the GPS tracking unit indicating that the GPS tracking unit 52 is within the proximity of the home base station 78 and continues in communication as long as the confirmation signal is received.

The Alternate embodiment of an automatic GPS tracking system, with passive battery circuitry, is illustrated in FIGS. 6 through 10 and consists of FIG. 6 a GPS tracking unit 52 that is configured to be secured onto a person 54 or an asset 56, as shown in FIG. 9. The GPS tracking unit 52 incorporates the following elements:

FIGS. 6 and 7 A first RF transceiver 62 communicating with RF signal, FIG. 9 with a home base station unit 78, demonstrating that the tracking unit 52 is within a pre-selected proximity communication distance 64.

FIGS. 6 and 7 A processor 66 is utilized that is programmed to control functions of the GPS tracking unit 52 and also controls pre-selected communication time intervals of the RF signal(s) from the first RF transceiver 62.

A first battery 72, preferably a Lithium type, supplies constant electrical power to both the first RF transceiver 62 and the processor 66.

A GPS receiver 58 in communication FIG. 9 with a plurality of satellites 60 acquires the specific physical location of the tracking unit 52.

FIGS. 6 and 7. A cellular modem 68 or a satellite modem 70 is utilized for communicating with FIG. 9 monitoring station 86.

FIGS. 6 and 7. A second battery 74, preferably a rechargeable Li Ion battery type, supplies electrical power to the GPS receiver 58, cellular modem 68, or a satellite modem 70. The power switching circuitry 76 interfaces with the second battery 74 powering on the second battery 74 only when the GPS tracking unit moves away from a pre-selected proximity communication 64 distance from the home base unit 78, and the RF confirmation signal(s) is not received from the home base unit 78 within the pre-selected time period. When GPS tracking unit 52 enters back into RF communication proximity distance 64, the GPS tracking unit re-establishes communication with the home base unit 78, and the power switching circuitry 76 switches OFF the second GPS receiver and cellular, satellite modem battery 74 for conserving the second battery 74 life.

The GPS tracking unit 52 is illustrated attached to the wrist of a person 54 in FIG. 9 and shown by itself in FIG. 6 and in relationship with other elements in the block diagram of FIG. 10 FIG. 9 The GPS tracking system 50 incorporates a home base station 78, illustrated in FIGS. 7 and 8, which includes the following:

A home base unit second RF transceiver 80 which communicates with RF signal(s) with the tracking unit first RF transceiver 62 and establishes a communication confirmation with the GPS tracking unit indicating that the GPS tracking unit 52 is within the proximity of the home base station 78 and continues in communication as long as the communication confirmation signal is received.

A land phone 82 or a cellular phone 84 may be utilized for establishing communication with the monitoring station 86.

A GPS tracking 52 unit may be used having only a receiver 62, and a home base station unit 78 may be used which contains a second RF transmitter 80, designed to emit at time interval RF signals, and GPS tracking unit 52 receiver 62 receiving the emitted signals, and creating power OFF position to the GPS receiver 58 and cellular or satellite modem circuitry 68, and creating cold start “Power ON” position to the GPS receiver 58 and cellular modem circuitry 68 only when the tracking unit moves away from a home base station 78 proximity communication range.

A portable battery operated asset or personnel mounted GPS tracking unit 44,49 and a automatic GPS tracking system unit 52 may further comprises a power On/Off switch (Not shown) and a optional vibrator 90 or a beeper 92 in electrical communication with the processor 12,22, 66. When the first RF transceiver 12,22, and 62 detects RF signal loss, or GPS tracking unit 44,49,52 is separated by more than a pre-selected proximity communication distance from the home base station unit 42,80 and or when the communication confirmation RF signal(s) is not received from the home base station unit 42,80, the processor 12,22 accordingly actuates the vibrator 90 or the beeper 92 creating a vibration or an audible alarm signal warning the person to turn ON the tracking unit 44,49,52 GPS receiver 10,20 and 58 and or cellular or satellite modem 11,21, 68 and 70 circuitry power switch into ON position using the first battery 15 and 72 or the second battery 25,74 as power source, to operate the GPS tracking unit 44,49,52. Or turn the GPS receiver 10,20, and 58 and or Cellular or satellite modem 11,21, and 68,70 circuitry power switch into OFF position when subject or asset to be monitored enters back into communication proximity of a home base unit 42,80.

To complete the basic GPS tracking system 50, a monitoring station 86 is utilized that consists of a computer or mobile PC 110 for receiving signals from the GPS tracking unit 52, through cellular modem or land phone 82, or for communicating with the GPS tracking unit 52.

Optionally the tracking unit 52 may include a vibrator 90 or a beeper 92, illustrated in FIG. 6, in electrical communication with the processor 66. The processor 66 is programmed to monitor a low battery condition or the absence of the second battery 74, from it's compartment and accordingly actuates the vibrator 90 or beeper 92 creating a vibration or an audible alarm signal warning the person 54 or asset 56 to replace or charge the second battery 74. The processor 66 is also programmed to transmit an RF or cellular signal to the monitoring station 86 containing information as to the second battery 74 condition. The vibrator 90 and beeper 92 are responsive to receive a signal from the monitoring station 86 through the home base unit second RF transceiver 80, the cellular modem 68 or the satellite modem 70, and accordingly vibrate and generate audible sounds providing a call tag notification for the person 54 to be monitored.

Another optional feature of the automatic GPS tracking system 50 utilizes a speaker 94 and a microphone 96, also illustrated in FIG. 6, interfacing with the cellular modem 68 or the satellite modem phone 70, utilizing the second battery 74 as a power source. The speaker 94 and microphone 96 are used to establish verbal communication between the person 54 to be monitored and the monitoring station 86 through the cellular or satellite phone modem 68,70 network or through home based unit 78 second RF transceiver 80 and phone line modem 82,84.

FIG. 9A wireless headset 98, including speakers and a microphone, may be carried by the person 54 to be monitored, and the GPS tracking unit 52 may contain an RF audio circuitry, connected to the first RF transceiver 62, to the cellular modem 68 or the satellite modem 70, to provide verbal communication between the person 54 to be monitored and the monitoring station 86 through the home base unit 78 second RF transceiver 80 land phone 82 line, or cellular phone 84, and establish verbal communication directly through the cellular, satellite phone line. 68,70.

Tamper protection circuitry 100 may be utilized in the automatic GPS tracking system 50 incorporating a strap 102 for attaching the tracking unit 52 onto the person 54 to be monitored. The processor 66 is programmed to contain comparator circuitry, which detects optical signal loss if security is breached by strap 102 removal. The tracking unit 52, using the first battery 72 power to transmit an RF signal containing information of a security breach; simultaneously a cellular signal or satellite signal is transmitted to the monitoring station 86 using power from the second battery 74.

The tamper protection circuitry 100 may be utilized with the asset 56, as illustrated in FIGS. 6 and 8 incorporating an optical light emitter 104 and an optical light collector 106 linearly aligned with a surface of the asset 56. The processor 66 is programmed to contain a comparator circuitry which detects optical reflection signal amplitude changes, when the GPS tracking unit 52 is tampered or removed from the asset 56, said tracking unit 52 transmits an RF signal containing information of a security breach using said first battery power 72, and simultaneously transmits a cellular signal or satellite signal to said monitoring station 86 using said second battery 74 power.

The GPS tracking unit 52 is attached to the asset 56 preferably with hook and loop tape 108 as illustrated in FIG. 8.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

1. A portable battery operated asset or personnel mounted GPS tracking system which comprises:
a GPS tracking unit having,
a first RF transceiver, and a processor,
a GPS receiver, and a cellular or satellite modem,
a battery, and a power switching circuitry. And
a home base station unit utilizing A/C or battery as power source, having a second RF transceiver.
Said first RF transceiver communicates at pre-set time interval with said home base station second RF transceiver unit when located within a specific communication range of said home base station, creating an “Off” position to said GPS receiver and said cellular or satellite modem power circuitry, to conserve battery consumption.
When a person or asset carrying said GPS tracking apparatus, moves away from said home base station, said first RF transceiver detects RF signal loss, and Cold start “Powers On”, said GPS tracking unit GPS receiver and or satellite or cellular modem circuitry to provide user automatic tracking, logging of asset or personnel movement. Said battery additional power consumption is in use only when said GPS tracking unit is out of RF communication proximity distance from said home base station to provide extended period of portable GPS tracking operation without the need of frequent battery charging.

2. The portable battery operated asset or personnel mounted GPS tracking system as claimed in claim 1, wherein said GPS tracking unit utilizes two sets of batteries, a first battery and a second battery, said first battery provides power to said RF transceiver to communicate at time intervals with said home base unit, and said second battery provides stand-by battery power to said GPS unit receiver and to said wireless modem to communicate with a monitoring station.

3. The portable battery operated asset or personnel mounted GPS tracking system as claimed in claim 2, wherein said GPS tracking unit first battery is rechargeable or none rechargeable and said second battery is rechargeable.

4. The portable battery operated asset or personnel mounted GPS tracking system as claim in claim 1 wherein said GPS tracking unit further having an optical motion sensor, said GPS tracking unit is installed on an asset or a person, said optical motion sensor detects tampering when said GPS tracking unit is removed from an asset or person to be monitored, and transmits tamper alarm signals.

5. An automatic GPS tracking system with passive battery circuitry which comprises a, person or an asset mounted GPS tracking unit and a home base station powered by A/C or battery, said GPS tracking unit comprises,
a RF transceiver, a processor, a GPS receiver and a cellular or a satellite modem utilizing a first battery as a power source for said RF transceiver and said processor,
a power switching circuitry, controls operation of a second battery used as a power source for said GPS receiver and said cellular or satellite modem,
wherein, said GPS tracking unit RF transceiver employing said first battery as a power source is in communication with said home base station which contains;
a RF transceiver emitting at time interval RF signals, and said home base unit transmitting said transmitted signals receipt confirmation signals to said tracking unit. When said GPS tracking unit is separated by more than a pre-selected proximity communication distance from said home base station unit, said processor automatically switch's ON said second battery power to activated said GPS receiver and or said cellular or satellite modem, to provide automatic personnel asset movement tracking/logging information to a monitoring station. Said GPS receiver and said cellular or said satellite modem circuitry consumes power from said secondary battery, only when person or asset to be monitored moves away from a pre-selected proximity communication area.

6. An automatic GPS tracking system with passive battery circuitry comprises:
a GPS tracking unit configured to be secured onto a person or an asset, said tracking unit having;
a first RF transceiver or receiver establishing communication confirmation with an RF signal(s) demonstrating that the tracking unit is within a pre-selected proximity communication distance;
a) a processor programmed to control functions of tracking unit, and control pre-selected time intervals to said communication confirmation RF signal(s);
a first battery, supplying constant electrical power to said first RF transceiver or receiver and to said processor;
a GPS receiver in communication with a plurality of satellites, acquiring a specific physical location of the tracking unit;
a cellular modem or a satellite modem for establishing communication between said GPS tracking unit and a monitoring station;
a second battery, supplying electrical power to said GPS receiver, and or a cellular or satellite modem only when said communication confirmation RF signal(s) is not received, and
a power switching circuitry interfacing with said second battery, powering on said second battery when said communication confirmation signal(s) is not received within a pre-selected proximity communication distance, such that power consumption of said second battery is conserved therefore lengthen battery life,
b) a home base station having;
a second RF transceiver communicating with confirmation RF signal(s) with said GPS tracking unit first RF transceiver, or said first receiver receiving emitted RF communication confirmation signal(s) from said home base station unit transmitter.
c) a monitoring station having;
a computer or mobile PC for receiving signals from said GPS tracking unit, and
a cellular phone/modem or a land phone/modem for communicating with said GPS tracking unit.

7. The automatic GPS tracking system as recited in claim 6 wherein said home base station further comprises a land phone and or a cellular phone/modem for establishing communication with said monitoring station when said RF signal and or confirmation signal is not received within a pre-selected proximity communication distance.

8. The automatic GPS tracking system as recited in claim 6 wherein said tracking unit further comprises a vibrator and or a beeper in electrical communication with said processor, said processor is programmed to detect said second battery absence from the battery compartment and or monitor a low battery condition of said second battery, and accordingly actuates said vibrator and or said beeper creating a vibration and or an audible alarm signal warning the person or asset to replace or charge the second battery, said processor may also be programmed to transmit an RF and or cellular or satellite signal to said monitoring station containing information as to said second battery condition.

9. The automatic GPS tracking system as recited in claim 8 wherein said tracking unit vibrator and or beeper are responsive to receive a signal from said monitoring station through said home base unit second RF transceiver and or through said cellular modem and or said satellite modem, and accordingly vibrate and or generate audible sounds providing a call tag notification for a person to be monitored.

10. The automatic GPS tracking system as recited in claim 9 wherein said tracking unit additionally contains a speaker and a microphone circuitry, utilizing the first battery for RF transceiver circuitry, and a second battery for cellular modem/phone circuitry, to establish a two way verbal communication with a monitoring station through said home base RF transceiver unit using a land line, and or use said cellular phone/modem to establish secure two way verbal communication.

11. The automatic GPS tracking system as recited in claim 10 wherein said tracking unit further comprises a wireless headset and microphone carried by said person to be monitored, and additional RF audio circuitry is being added within said GPS tracking unit, to establish wireless communications between said wireless headset, and said cellular modem and or said satellite modem, to provide verbal communication between said person to be monitored and said monitoring station.

12. The automatic GPS tracking system as recited in claim 6 wherein said tracking unit further comprises tamper protection circuitry incorporating an strap for attaching said tracking unit onto said person or asset to be monitored, said processor, contains comparator circuitry which detects optical signal changes or loss if security is breached by strap removal, the tracking unit using said first battery power transmits an RF signal(s) containing information of a security breach, and or a cellular signal or satellite signal is transmitted to said monitoring station, using said second battery power.

13. The automatic GPS tracking system as recited in claim 6 wherein said tracking unit further comprises tamper protection circuitry, incorporating a optical light emitter and a optical light collector linearly aligned with a surface of said asset, said processor contains a comparator circuitry which detects optical reflection signal amplitude changes, when said GPS tracking unit is tampered or removed from the asset, said comparator detects optical light amplitude change, and accordingly said tracking unit transmits an RF signal(s) containing information of a security breach using said first battery power, or transmits a cellular signal or satellite signal to said monitoring station using said second battery power.

14. The portable battery operated asset or personnel mounted GPS tracking system as in claim 1 and the automatic GPS tracking system as claimed in claim 5 and 6, wherein said GPS tracking unit further comprises a power On/Off switch and a vibrator and or a beeper in electrical communication with said processor. When said first RF transceiver detects RF signal loss, or GPS tracking unit is separated by more than a pre-selected proximity communication distance from said home base station unit and or when said communication confirmation RF signal(s) is not received from a home base station unit, said processor accordingly actuates said vibrator and or said beeper creating a vibration and or an audible alarm signal warning the person to turn ON said GPS receiver and or cellular or satellite modem circuitry power switch into ON position, using said first battery and or said second battery as power source. Or said vibrator and or beeper creating a vibration and or audible signal(s) alerting the person to turn the GPS receiver and or Cellular or satellite modem circuitry power switch into OFF position when subject or asset to be monitored enters back into communication proximity of a home base unit.
